(19) United States
(12) Patent Application Publication
(10) Pub. No.: US 2015/0267456 A1
(43) Pub. Date: Sep. 24, 2015

(54) AUTOMATIC MULTI SLIDE DOORS DEVICE

(71) Applicant: Advanced Equipment System Co., Ltd., Taipei City (TW)

(72) Inventor: Chih-Jen SHIH, New Taipei City (TW)

(21) Appl. No.: 14/664,283

(22) Filed: Mar. 20, 2015

(30) Foreign Application Priority Data
Mar. 21, 2014 (TW) 103204882

(51) Int. Cl. E05F 15/643; E05F 15/635; E05F 15/652; E05F 15/50; E05F 15/70

(52) U.S. Cl. CPC E05F 15/643; E05F 15/50; E05F 15/70; E05F 15/652; E05F 15/635

(57) ABSTRACT

A multi slide doors device comprises a frame, a power module, a guide pulley module and a plurality of door panels. The first door panel is operated by the power module to move upward or downward. Simultaneously, the second door panel also moves in the same direction with a different moving distance by the transmission of the pulleys in the pulley module. The moving distance of the second door panel is larger than that of the first door panel. In this way, the plurality of door panels can be opened or closed quickly so that the defect of spending long time in opening or closing due to in-sequence moving of door panels and of inconvenient maintenance due to complexity in designing of convention technology can be improved.

### BACKGROUND OF THE INVENTION

1. Field of the Invention

The present invention relates to an automatic multi slide doors device, more particularly to a multi slide doors device which enables quick opening and closing of door panels by adopting movable pulleys.

2. Brief Description of Prior Arts

Modern industries have already been in automation control stage, therefore the demand of automatic door device is up growing and is fused in people's daily life, such as automatic doors used in public transportation, home garage, and factory entrance. In addition, experiment cabinets used in laboratory or large machinery equipments often have application of automatic doors. When the door is closed, the operator can be isolated from the machinery equipment so as to prevent the operator from mechanical disasters. The automatic door is powered by either electric, pneumatic or hydraulic means so that the door panels can be opened or closed. Typically, the structure of an automatic door has a plurality of door panels, and the door panels of the conventional automatic door device are often operated in sequence, such as the description mentioned in the following prior art for reference:
(1) Taiwanese Patent Gazette No. M344385 entitled “Balancing Weight device”
(2) Taiwanese Patent Gazette No. M349960 entitled “Folding Device Enabling Flexible Adjustment”

However, it is apparent from the description disclosed in the prior art that the in-sequence operation of a plurality of door panels often takes a long time in door opening and closing, as the first door panel will drive the second door panel to move downward until the first door panel itself moves downward to a predetermined position. There is an additional prior art in which an automatic door having a structure with pulleys and gears combined together to achieve quick opening and closing of door panels is disclosed as shown in FIG. 1. Referring to FIG. 1, the automatic door device 10 is formed by two struts 101, a pneumatic cylinder 102, a gear module 103, a plurality of pulleys 104 and a plurality of door panels (105, 106, 107). The plurality of door panels (105, 106, 107) are disposed between the two struts 101. The first door panel 105 and the second door panel 106 both have a plurality of pulleys 104 attached therewith, so that the first door panel 105 and the second door panel 106 can slide either upward or downward between the two struts 101. While the third door panel 107 is usually in stationary state. The pneumatic cylinder 102 is connected with one end at one side of the second door panel 106 through a connecting member 1021. The gear module 103 includes a gear 1031, which is rotatably disposed on the other end at one side of the second door panel 106, and a rack 1032 meshed with the gear 1031, one end of the rack 1032 is fixed on the first door panel 105 (not shown in figure) and the other end is fixed on the strut 101. When the pneumatic cylinder 102 is filled with compressed air or the compressed air is released therefrom, the connecting member 1021 can be operated to move, so as to drive the second door panel 106 and the gear 1031 moving the same distance as the connecting member 1021. Furthermore, the second door panel 106 is operated by the combination of the gear 1031 and the rack 1032 to move simultaneously so as to achieve the effect of quick opening or closing. There are still another prior art for reference:
(1) China Patent Gazette No. CN 2461961 entitle “Hydraulic Water Gate”
(2) US Patent Gazette No. U.S. Pat. No. 8,272,179 entitled “Work Station Safety Barrier”
(3) US Patent Gazette No. U.S. Pat. No. 6,311,757 entitled “Door or Gate Closure”

However, it is apparent from the above prior art that those automatic doors devices enabling quick opening and closing of door panels disclosed in the prior art are all provided with a mechanical structure containing a plurality of pulleys (including stationary and movable pulleys) and gears. This often causes complexity in internal structure and may results in inconvenient maintenance of the automatic doors device. Moreover, the more the mechanical transmission mechanisms are provided, the bigger the maximum static friction becomes, so that much more energy is required to operate the automatic multi slide doors device. Therefore, how to reduce the complexity of the structural design of device and still enabling the effect of quick opening and closing of door panels is a big issue of the present invention.

### SUMMARY OF THE INVENTION

In view of the above mentioned problems, the inventor proposes a better entity product based on his abundant experience in product development and manufacturing in relevant field for a couple of years and according to the research and analysis conducted on the convention automatic doors device. Therefore, the main object of the present invention is to provide an automatic multi slide doors device enabling quick opening and closing of door panels.

In order to achieve above objects, the automatic multi slide doors device of the present invention mainly comprises a frame body, a power module, a guiding pulley module and a plurality of door panels. The pluralities of door panels are assembled on the frame body. The power module is disposed on one end of the frame body and is fixedly connected with the first door panel through a first connecting member and a second connecting member. Furthermore, the guiding pulley module includes a first pulley and a first rope. The first pulley is disposed on one end of the first door panel, while the first rope is wounded around the first pulley, one end of the first rope is fixed on the frame body and the other end thereof is fixed on the second door panel. Therefore, when the power module provides a power source to operate the first door panel to move, the second door panel simultaneously moves in the same direction as the first door panel by the transmission action of the guiding pulley module, and the moving distance of the second door panel is larger than that of the first door panel.

### BRIEF DESCRIPTION OF ACCOMPANYING DRAWINGS

The present invention will be better understood by the detailed description of a preferred embodiment with reference to the accompanied drawings, in which:

FIG. 1 is a schematic view of a conventional automatic multi slide doors device;

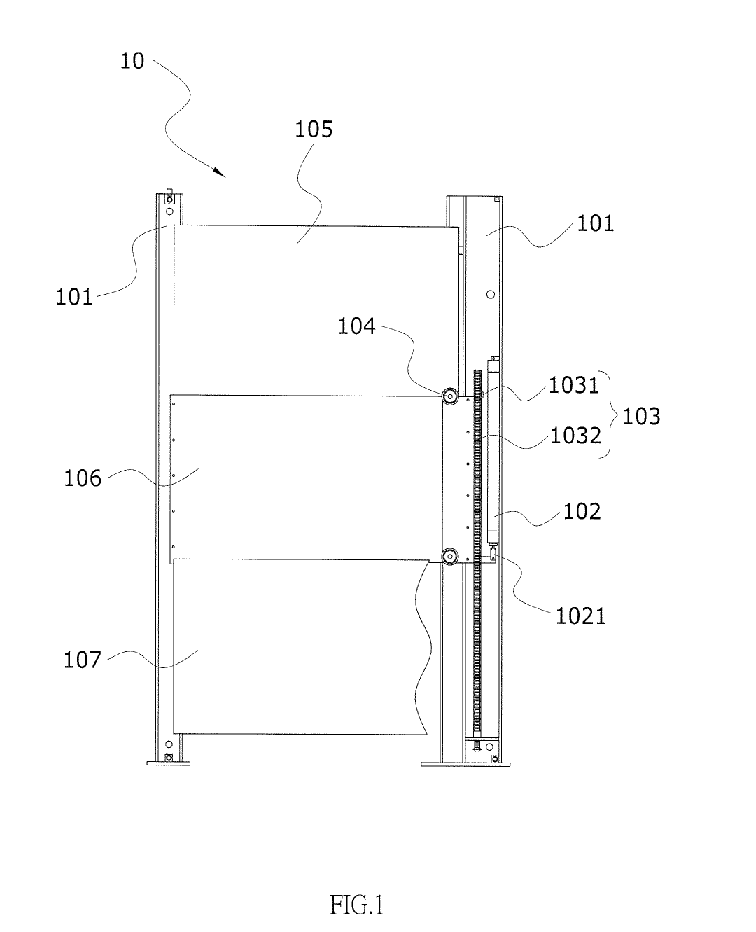

FIG. 2 is a perspective schematic view showing the appearance of the present invention;

FIG. 3 is a detailed view (I) of the structure of the present invention;

FIG. 4 is a detailed view (II) of the structure of the present invention;

FIG. 5 is a detailed view (III) of the structure of the present invention;

FIG. 6 is a detailed view (IV) of the structure of the present invention;

FIG. 7 is a schematic view showing the implementation of the present invention;

FIG. 8 is a schematic view of a still another embodiment (I) of the present invention;

FIG. 9 is a schematic view of a still another embodiment (II) of the present invention;

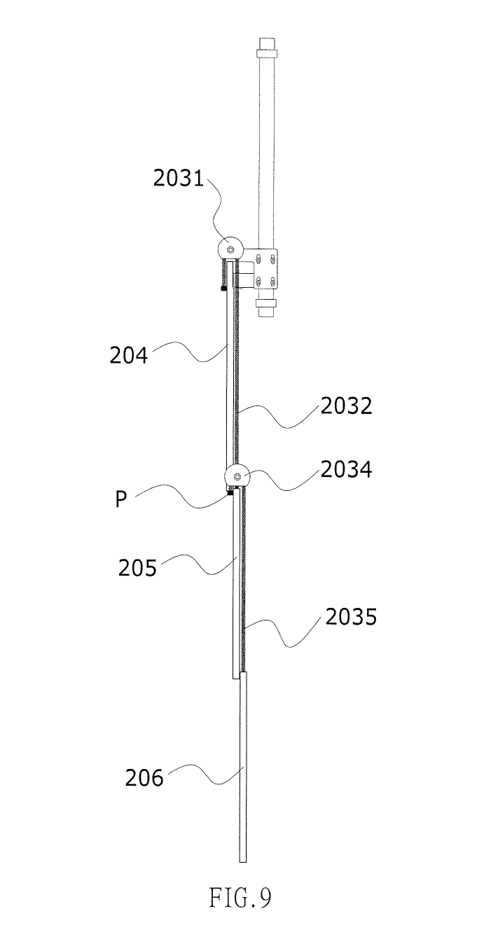

FIG. 10 is a schematic view of a still another embodiment (III) of the present invention.

### DETAILED DESCRIPTION OF PREFERRED EMBODIMENTS

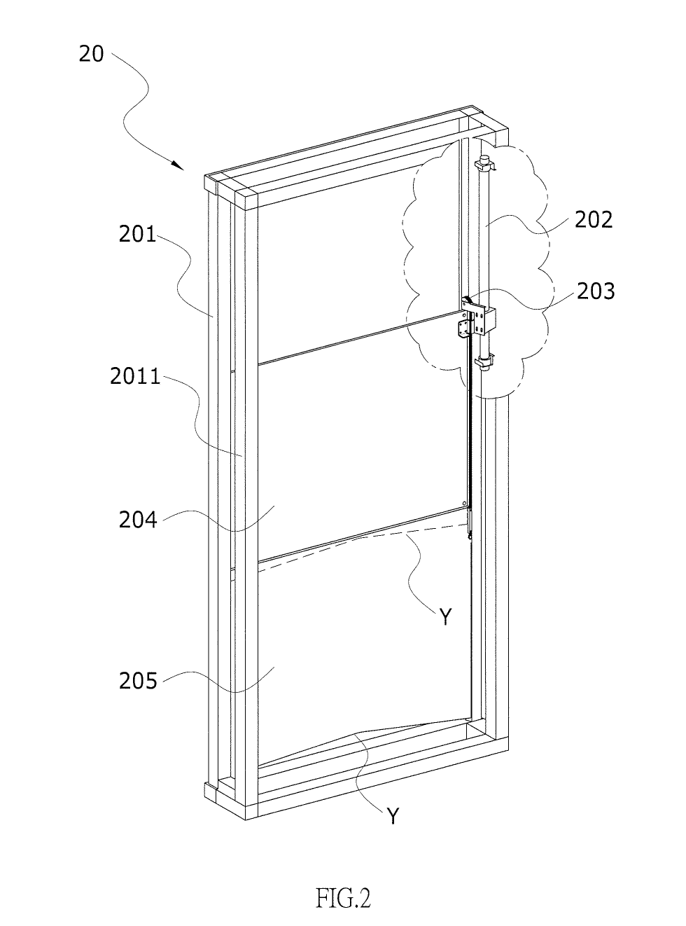

Referring to FIG. 2, the automatic multi slide doors device 20 of the present invention is mainly formed by a frame body 201, a power module 202, a guiding pulley module 203, a first door panel 204 and a second door panel 205. The frame body 201 includes a plurality of struts 2011; the first door panel 204 and a second door panel 205 are assembled between at least two struts 2011 in such a manner that the first door panel 204 is disposed above the second door panel 205. Each of the first door panel 204 and the second door panel 205 has a design of inclined angle Y provided on the lower edge such that the cutting liquid attached to the first door panel 204 or the second door panel 205 can be guided by the inclined angle Y to flow toward both sides so as to prevent the cutting liquid (not shown in figure) from dropping down onto the inlet or the outlet upon the opening of the door panels. The power module 202, which is to provide power source, is assembled on one end of one strut 2011 and is fixedly connected with the first door panel 204. The guiding pulley module 203 is a simple mechanical structure of pulley, which is assembled on one end of the first door panel 204 and is fixedly connected with the power module 202 and second door panel 205. Therefore, when the power module 202 actuates the first door panel 204 to move upward, the second door panel 205 also moves upward by the transmission action of the guiding pulley module 203.

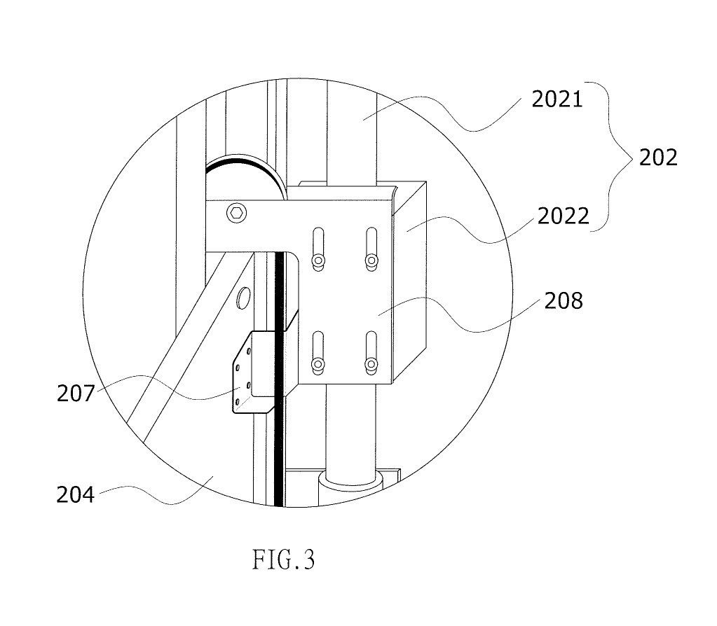

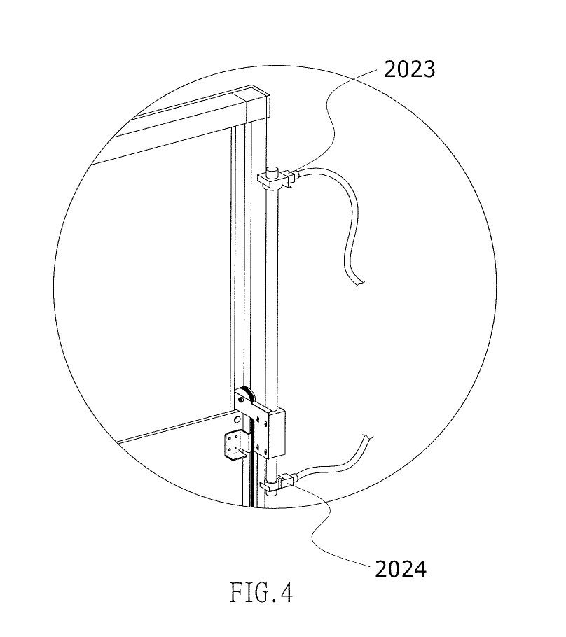

Referring to FIG. 3, the power module 202 includes an actuating unit 2021 and an interlocking unit 2022. The actuating unit 2021 is assembled on one end of one strut 2011, as shown in FIG. 2. The actuating unit 2021 can be a device enabling the transformation of rotary motion into linear motion, and which can be anyone of a pneumatic cylinder, a hydraulic cylinder, a linear motor, a rotary motor combined with a lead screw or a reel, but is not limited to the above. The interlocking unit 2022 is assembled on the actuating unit 2021 and can conduct linear reciprocate motion thereon. Furthermore, the interlocking unit 2022 is fixedly connected with the first door panel 204 through a first connecting member 207 and a second connecting member 208. The first connecting member 207 can be formed in advance on the second connecting member 208 or can be assembled thereon subsequently. Referring to FIG. 4, the actuating unit 2021 comprises a first pressure input and output terminal 2023 and a second pressure input and output terminal 2024 to conduct charging of a pressurized fluid into the interior of the actuating unit 2021 or releasing of the pressurized fluid therefrom. The pressurized fluid can be either compressed air (in case the actuating unit 2021 is a pneumatic cylinder) or pressurized liquid (in case the actuating unit 2021 is a hydraulic cylinder), but is not limited to this. Therefore, by performing the charging of a pressurized fluid into the interior of the actuating unit 2021 or releasing the pressurized fluid therefrom through the first pressure input and output terminal 2023 and the second pressure input and output terminal 2024, the interlocking unit 2022 can be actuated to move and to drive the first door panel 204 to move in the same direction.

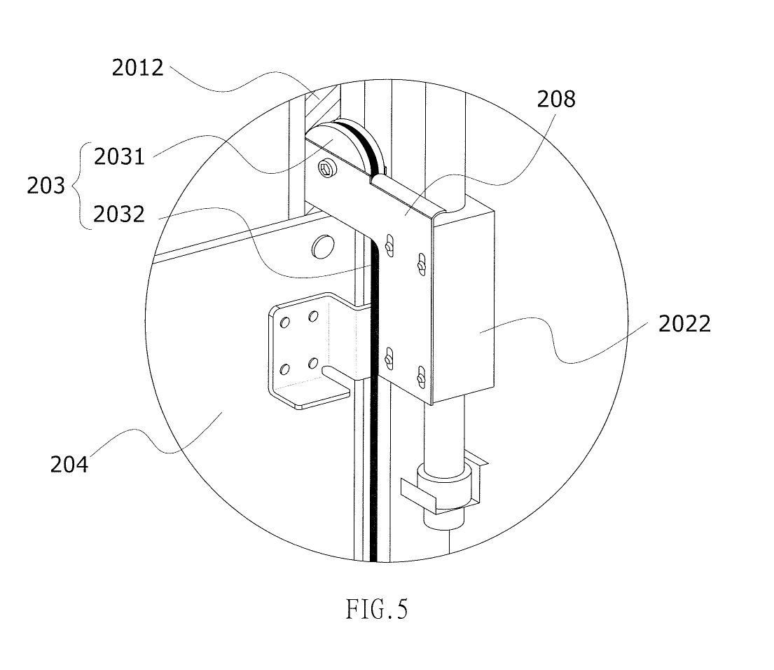

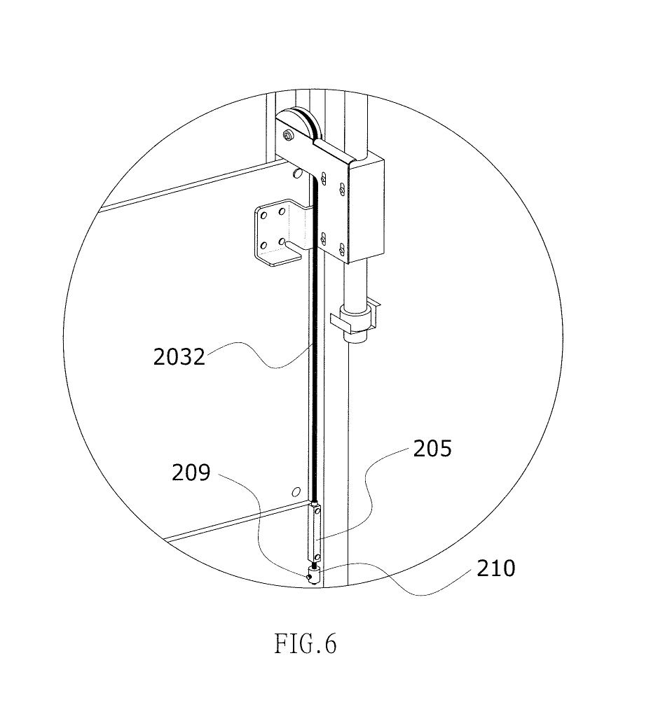

Referring to FIG. 5 and FIG. 2, the guiding pulley module 203 includes a first pulley 2031 and a first rope 2032. The first pulley 2031 is assembled on one end of the first door panel 204 and is received within a slide channel 2012 of the strut 2011. Furthermore, the first pulley 2031 is fixedly connected with the interlocking unit 2022 through the second connecting member 208. As the central shaft of the first pulley 2031 is in movable state, the first pulley 2031 is a mechanical structure of a movable pulley. Further, the first rope 2032 can be either a cable or a chain which is wound around the first pulley 2031, but is not limited to this. Referring to FIG. 6, one end of the first rope 2032 is fixed on the strut 2011 (not shown in figure) and the other end is fixed on the second door panel 205. In a preferred embodiment of the present invention, the other end of the first rope 2032 is penetrated through the second door panel 205 and is locked on the first counterpart lock member 210 through a first lock member 209. Accordingly, the first rope 2032 can pull the second door panel 205 to move by the transmission of the first pulley 2031. As the first rope 2032 is penetrated through the second door panel 205 and the second door panel 205 descends by its own weight (i.e., by the weight of the second door panel 205 itself only), even when the second door panel 205 is obstructed by an obstacle to stop the movement, the first rope 2032 can still be operated according to its original movement route so that the obstacle can only bear the weight of the second door panel 205. When the obstacle is an operator, the damage to the operator can be suppressed to minimum. Therefore, additional sensing device is not required and the present invention is not that easy to be damaged from the obstruction by the obstacle. In addition, by the weights of the first lock member 209 and the first counterpart lock 201, bending resulted from the obstruction of the second door panel by an obstacle is not occurred on the first rope 2032 during its operation process.

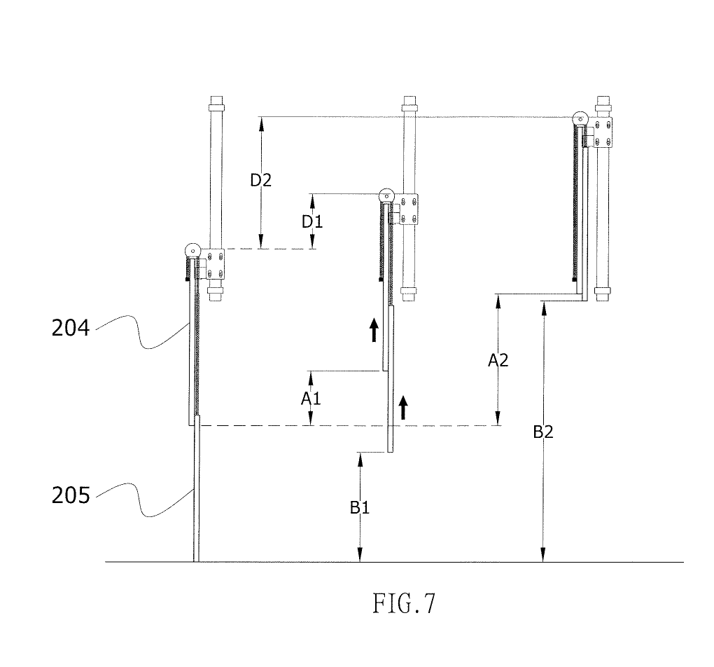

Referring to FIG. 7 in collocation with FIGS. 3 to 6, after the charging of a pressurized fluid into the interior of the actuating unit 2021 or releasing of the pressurized fluid therefrom through the first pressure input and output terminal 2023 and the second pressure input and output terminal 2024, the interlocking unit 2022 is actuated to move upward a distance D1, and further to drive the first door panel 204 to move the same distance A1 in the same direction, i.e., A1 is equal to D1. Moreover, the first rope 2032 can pull the second door panel 205 to move a different distance B1 in the same direction by the transmission of the first pulley 2031, i.e., B1>A1. In the preferred embodiment, the distance B1 is two times the distance A1. Therefore, when the actuating unit 2021 actuates the interlocking unit 2022 to move upward from its bottom to the top (i.e., the distance D2), the first door panel 204 moves upward a distance A2 consistent with the distance D2, and reaches its fully opened state. Simultaneously, the second door panel 205 moves upward a distance B2 which is double the distance A2 (the moving speed of the second door panel 205 is double that of the first door panel 204). Therefore, the first door panel 204 and the second door panel 205 can simultaneously reach fully opened state. Further, the actuation for the door closing is the same as above, and is omitted here accordingly.

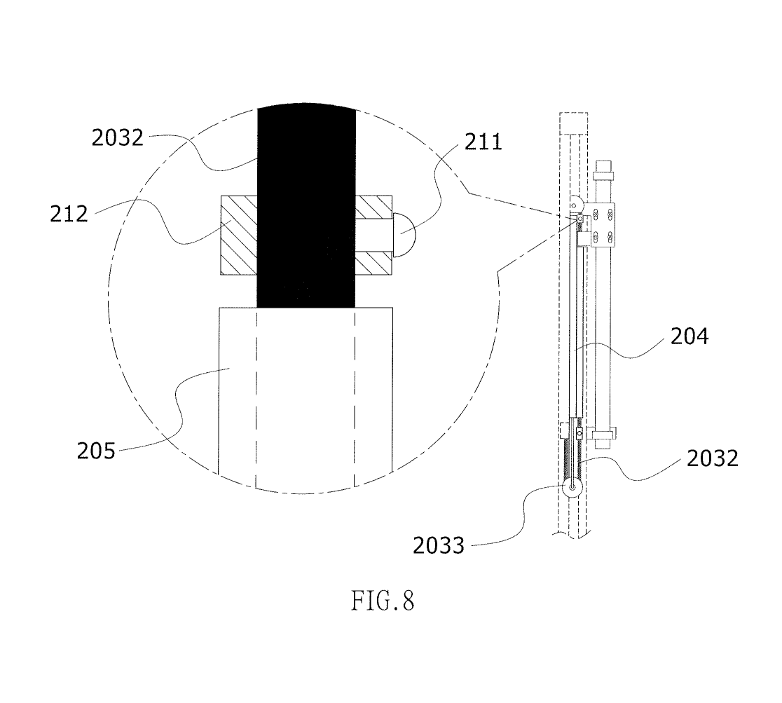

Referring to FIG. 8 in collocation with FIG. 5, the guiding pulley module 203 includes a second pulley 2033 which is assembled on the other end of the first door panel 204 and is similarly received in the slide channel 2012. Furthermore, the first rope 2032 is wound around the second pulley 2033 and both ends of the first rope 2032 are fixed on the frame body 201 (not shown in figure). Moreover, the first rope 2032 located above the second door panel 205 is assembled with a second lock member 211 which is mated with a second counterpart lock member 212 to lock with each other. When the first door panel 204 move downward, the second pulley 2033 is interlocked to drive the second lock member 211 together with the second counterpart lock member 212 to move downward, and further to drive the second door panel 205 to move. Therefore, the failure of actuation in accordance with a predetermined stroke because the weight of the second door panel 205 being less than the frictional force can be solved.

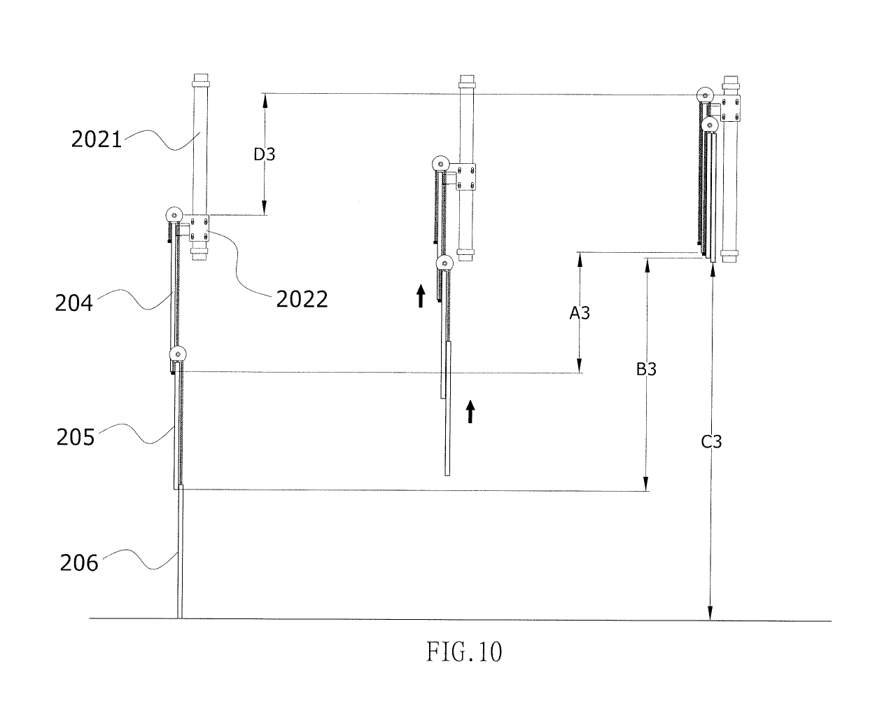

Referring to FIG. 10 in collocation with FIG. 2, the automatic multi slide doors device 20 of the present invention can also be implemented in the case having more than two door panels. In this embodiment, the case having three door panels is taken as an example. As shown in the figures, a third door panel 206 is assembled between at least two struts 2011, and the third door panel 206 is disposed below the second door panel 205. Further, the guiding pulley module 203 additionally includes a third pulley 2034 and a second rope 2035. The third pulley 2034 is assembled on one end of the second door panel 205. As the central shaft of the third pulley 2034 is in movable state, the third pulley 2034 is a mechanical structure of a movable pulley. Further, the second rope 2035 can be either a cable or a chain wound around the third pulley 2034, but it is not limited to this. One end of the second rope 2035 is fixed on a fixed point P of the first door panel 204, and the other end is fixed on the third door panel 206. When the first door panel 204 moves upward, the second door panel 205 also moves upward by the transmission action of the first pulley 2031 and the first rope 2032, and the third door panel 206 moves upward simultaneously by the transmission action of the second pulley 2033 and the second rope 2035. The moving distance of the second door panel 205 is two times that of the first door panel 204, while the moving distance of the third door panel 206 is three times that of the first door panel 204. In other words, the moving distance of the Nth door panel is N times that of the first door panel 204 (the moving speed of the Nth door panel is N times that of the first door panel 204). Referring to FIG. 10, when the actuating unit 2021 actuates the interlocking unit 2022 to move upward from its bottom to the top (i.e., the distance D3), the first door panel 204 moves upward a distance A3 and reaches its fully opened state. Simultaneously, the second door panel 205 moves upward a distance B3 which is two times of the distance A3, and the third door panel 206 moves upward a distance C3 which is three times the distance A3. Therefore, the first door panel 204, the second door panel 205 and the third door panel 206 can simultaneously reach fully opened state. Further, the actuation for the door closing is the same as above, and is omitted here accordingly.

Based on foregoing, the automatic multi slide doors device of the present invention is mainly formed by a frame body, a power module, a guiding pulley module, a first door panel and a second door panel. The frame body includes at least two struts for assembling the first door panel, the second door panel and the power module. The power module includes an actuating unit and an interlocking unit. The interlocking unit is disposed on the actuating unit and is fixedly connected with the first door panel through a first connecting member and a second connecting member. Moreover, the guiding pulley module includes a first pulley and a first rope. The first pulley is assembled on one end of the first door panel and is fixedly connected with the interlocking unit through the second connecting member. Furthermore, the first rope is wound around the first pulley, one end of the first rope is fixed on the strut and the other end thereof is fixed on the second door panel. Alternatively, the other end of the first rope can be penetrated through the second door panel and then is locked with a counterpart lock through a first lock member. Therefore, when the actuating unit operates the interlocking unit to move a certain distance, the first door panel is driven to move a same distance in the same direction; and the first rope can pull the second door panel to move a different distance in the same direction by the transmission action of the first pulley, and the moving distance of the second door panel is greater than that of the first door panel. In this manner, the present invention implements based on above can surely achieve the object of providing an automatic multi slide doors device enabling quick opening and closing of the door panels.

While the present invention has been described by preferred embodiments in conjunction with accompanying drawings, it should be understood the embodiments and the drawings are merely for descriptive and illustrative purpose, not intended for restriction of the scope of the present invention. Equivalent variations and modifications conducted by person skilled in the art without departing from the spirit and scope of the present invention should be considered to be still within the scope of the present invention.

1. An automatic multi slide doors device, comprising:
a frame body formed by at least two struts;
a first door panel and a second door panel respectively assembled between at least two struts;
a power module including an actuating unit and an interlocking unit, said actuating unit being assembled on one end of one said strut, said interlocking unit being assembled on said actuating unit and being able to conduct linear reciprocating movement thereon; said interlocking unit being fixedly connected with said first door panel so that said first door panel can be driven to move by the sliding movement of said interlocking unit itself; and
a guiding pulley module including a first pulley and a first rope; said first pulley being assembled on one end of said first door panel and being fixedly connected with said interlocking unit; said first rope being wound around said first pulley, one end of said first rope being fixed on said frame body and the other end thereof being fixed on said second door panel so that said second door panel can be pulled to move by the movement of said first door panel.

2. The automatic multi slide doors device as claimed in claim 1, wherein the moving distance of said second door panel is greater than that of said first door panel.

3. The automatic multi slide doors device as claimed in claim 1, wherein said actuating unit is anyone selected from: a pneumatic cylinder, a hydraulic cylinder, a linear motor, a combination of a rotary motor and a lead screw, a combination of a rotary motor and a reel.

4. The automatic multi slide doors device as claimed in claim 3, wherein said actuating unit has a first pressure input and output terminal and a second pressure input and output terminal for charging or releasing a pressurized fluid.

5. The automatic multi slide doors device as claimed in claim 1, wherein said interlocking unit is fixedly connected with said first door panel through a first connecting member and a second connecting member; said first pulley is fixedly connected with said interlocking unit through said second connecting member; said first connecting member can be preformed on said second connecting member or is assembled on said second connecting member subsequently.

6. The automatic multi slide doors device as claimed in claim 1, wherein one end of said first rope is fixed on said frame body and the other end thereof penetrates through said second door panel, and is locked on a first lock member through a first counterpart lock member.

7. The automatic multi slide doors device as claimed in claim 6, wherein said first rope is located above said second door panel, said first rope has a second lock member which has a second counterpart lock member.

8. The automatic multi slide doors device as claimed in claim 1, wherein said guiding pulley module includes a second pulley which is assembled on the other end of said first door panel.

9. The automatic multi slide doors device as claimed in claim 8, wherein said strut is formed with a slide channel for receiving said first pulley and said second pulley.

10. The automatic multi slide doors device as claimed in claim 1, wherein said automatic multi slide doors device further comprises a third door panel, a third pulley and a second rope; said third door panel being assembled between at least two struts; said third pulley being assembled on one end of said second door panel; said second rope being wound around said third pulley, one end of said second rope being fixed on said first door panel and the other end thereof being fixed on said third door panel so that said third door panel can be pulled to move upon the movement of said second door panel.

11. The automatic multi slide doors device as claimed in claim 10, wherein the moving distance of said second door panel is double the moving distance of said first door panel, and the moving distance of said third door panel is triple the moving distance of said first door panel.
